(19) United States
(12) Patent Application Publication
(10) Pub. No.: US 2012/0159624 A1
(43) Pub. Date: Jun. 21, 2012

(54) COMPUTER SECURITY METHOD, SYSTEM AND MODEL

(75) Inventor: Christoph König, Ottobrunn (DE)

(73) Assignee: Fujitsu Technology Solutions Intellectual Property GmbH, Munich (DE)

(21) Appl. No.: 12/974,328

(22) Filed: Dec. 21, 2010

(51) Int. Cl. G06F 21/00

(52) U.S. Cl. 726/23

(57) ABSTRACT

A computer security method includes receiving a security alert associated with an electronic attack to at least one computer system of a data network, identifying a first set of business services which may be affected by the electronic attack, estimating, based on an identified first set of potentially affected business services, a first potential cost to a business when the electronic attack is successful, identifying at least one counteraction which may be employed to prevent or mitigate the electronic attack, identifying a second set of business services which may be affected by the at least one counteraction, estimating, based on the identified second set of potentially affected business services, a second potential cost to the business when the counteraction is employed, and comparing the first potential cost and the second potential cost.

### TECHNICAL FIELD

This disclosure relates to computer security in general. More particularly, the disclosure relates to methods, systems and models aimed at improving reactions to received security alerts.

### BACKGROUND

Terms like security, cyber security, IT or service availability and disaster recovery are often mentioned together when issues related to computer security such as virus or denial of service attacks are discussed. There is a general appreciation that computer security and business availability should be linked. The known approaches of addressing these disparate problems, however, have remained woefully inadequate and static over the last couple of years. While people responsible for IT security and business availability are sometimes organized in the same or related departments of an organization, cooperation between technical aspects related to computer security on the one hand and business aspects related to service availability on the other hand remains unsatisfactory.

The existing problems are aggravated by the fact that electronic attacks are on the rise, both in intensity and frequency. For example, viruses spread over the Internet and are capable of attacking and potentially disabling hundreds if not thousands or even tens of thousands of computer systems or services of a particular type or of a particular company within minutes if not seconds of the first detection of the attack. In situations like these, manual interference by system administrators and other people responsible for computer security is often inadequate to counter any impeding or ongoing threat.

In some situations, a quick deactivation of systems or services under attack is the only feasible reaction available to system administrators. However, completely deactivating a resource or business service may often result in high cost to the business of a company and are therefore discouraged in all but the most severe attacks.

It could therefore be helpful to provide improved computer security methods, systems and models that mitigate at least some of the problems set out above. It could further be helpful to provide methods, systems and models that aid system administrators and people responsible for service availability to improve their responses to imminent or ongoing threats posed by electronic attacks. It could yet further be helpful to provide systems, methods and models that can be employed to counter any electronic attack automatically.

### SUMMARY

I provide a computer security method, including receiving a security alert associated with an electronic attack to at least one computer system of a data network, identifying a first set of business services which may be affected by the electronic attack, estimating, based on an identified first set of potentially affected business services, a first potential cost to a business when the electronic attack is successful, identifying at least one counteraction which may be employed to prevent or mitigate the electronic attack, identifying a second set of business services which may be affected by the at least one counteraction, estimating, based on the identified second set of potentially affected business services, a second potential cost to the business when the counteraction is employed; and comparing the first potential cost and the second potential cost.

I also provide a computer security system, including a resource model that associates business services provided by at least one data network with resources of the at least one data network, a business impact model that provides estimates of monetary cost caused by disturbances of each one of the business services, a security alert module that maps a received security alert associated with an electronic attack to at least one resource of the at least one data network targeted by the electronic attack; and a defense system that provides possible counteractions to a received security alert, wherein the defense system selects at least one counteraction based on the estimate cost of employing the at least one counteraction provided by the business impact model.

I further provide a computer security model for use in a software product for assessing a business impact of an electronic attack, the model including alerts associated with an electronic attack for assessing a received security alert, targets associated with resources of at least one data network for mapping a received security alert to at least one resource, counteractions associated with at least one of an alert and a target for preventing or mitigating the electronic attack, and business impacts associated with at least one of a target and a counteraction for providing an estimated cost on a business service of a successful attack or employed counteraction, respectively.

### BRIEF DESCRIPTION OF THE DRAWINGS

My methods, systems and models will be described with reference to different examples of those methods, systems and models used to improve computer security. The examples will be described with reference to the following figures:

FIG. 1 shows an example of a computer security system;

FIG. 2 shows a flow chart of an example of a computer security method;

FIG. 3 shows a flow chart of an example of method steps for processing a security alert.

FIG. 4 shows a flow chart of an example of method steps for estimating costs of an electronic attack or a counteraction employed.

FIG. 5 shows a model used in a software product for improving computer security.

### DETAILED DESCRIPTION

It will be appreciated that the following description is intended to refer to specific examples of structure selected for illustration in the drawings and is not intended to define or limit the disclosure, other than in the appended claims.

According to a first example, a computer security method comprises receiving a security alert associated with an electronic attack to at least one computer system of a data network. In response thereto, a first set of business services is identified which may be affected by the electronic attack. Then, based on the identified first set of potentially affected business services, a first potential cost to the business in case the electronic attack is successful is estimated. Moreover, at least one counteraction which may be employed to prevent or mitigate the electronic attack is identified. Furthermore, a second set of business services which may be affected by the at least one counteraction is identified. Based on the identified second set of potentially affected business services, a second potential cost to the business in case the counteraction is employed is estimated. Finally, the first potential cost and the second potential cost are compared.

The described computer security model enables an informed risk management in view of an electronic attack. In particular, system administrators can compare costs imposed by an electronic attack with the costs associated with one or more potential counteractions used to mitigate the electronic attack, thus increasing cost-awareness.

According to further examples, a suggestion to an operator of the at least one computer system to employ the at least one counteraction can be displayed if the first potential cost is higher than the second potential cost. Inversely, a warning to an operator of the at least one computer system not to employ the at least one counteraction can be displayed if the first potential cost is lower than the second potential cost.

Furthermore, the at least one counteraction can be employed with an automatic administration interface of the at least one computer system if the first potential cost is higher than the second potential cost. This allows a fast, business aware implementation of automated computer security, which reacts almost instantaneously to detected security alerts.

According to a further example, in the step of identifying at least one counteraction, a plurality of possible counteractions is identified and the steps of identifying the second set of business services and estimating the second potential cost are performed for each one of the identified possible counteractions. Based on the step of comparing, the possible counteraction having the least associated second cost is selected. Consideration and evaluation of several potential counteractions allows a manual or fully automated computer security method to select the best possible counteraction in terms of cost to the business.

According to one example, the security alert is classified according to a plurality of predefined threat types and the possible counteractions are provided based on the classification of the security alert. Such a method is particularly useful to identify virus attacks, denial of service attacks, back door attacks, database query attacks, service discovery attacks, and hacking attacks.

According to a further example, the first potential cost is estimated based on the likelihood of the success of an electronic attack. Taking the likelihood of success into consideration can improve the prediction quality of the computer security method.

According to a further example, a plurality of security alerts associated with the electronic attack is received from a plurality of computer systems and the likelihood of the success of the electronic attack is determined based on the plurality of received security alerts. By correlating and analyzing a plurality of security alerts, among others, the speed of the spread of a particular electronic attack can be estimated and taken into account in the evaluation of the likelihood of success.

According to further examples, the first and second potential costs are estimated based on at least one of the type of business service affected, the number of users affected, and the time of the day, week or year. Taking these and similar information into consideration, the quality of the decisions can be further improved. In particular, the computer security method can take into account the fact that an impact of an attack or a countermeasure may be much lower outside business hours than it is during business hours.

According to a second example, a computer security system comprising a resource model that associates business services provided by at least one data network with resources of the at least one data network is provided. The computer security system further comprises a business impact model that provides estimates of monetary cost caused by disturbances of each one of the business services and a security alert module that maps a receive security alert associated with an electronic attack to at least one resource of the at least one data network targeted by the electronic attack. The computer security system further comprises a defense system that provides possible counteractions to a received security alert, wherein the defense system selects at least one counteraction based on the estimated cost of employing the at least one counteraction provided by the business impact model. A computer security system comprising a defense system that can make informed decisions based on a resource model and a business impact model can react quickly and effectively to security alerts received by a security alert module.

According to one example, the defense system selectively deactivates resources and/or business services of the at least one data network to counteract the electronic attack and the business impact model estimates the cost of the counteraction based on the estimated cost of disabling the business services depending on the deactivated resources and/or business services, respectively. Fast deactivation of individual resources or business services in response to a detected security alert can effectively counteract an electronic attack. By taking the cost of the deactivation into account, disproportionate reactions can be avoided.

According to a further example, the security alert module comprises a knowledge database for associating received security alerts with resources of the at least one data network based on at least one of automated learning from, statistical analysis of and heuristics based on previous electronic attacks. Taking into account knowledge from previous attacks, the quality of decisions taken and potentially implemented by the computer security system can be improved over time.

According to a third example, a computer security model for use in a software product that assesses a business impact of an electronic attack is described. The model comprises alerts associated with an electronic attack for assessing a received security alert, targets associated with resources of at least one data network for mapping a received security alert to at least one resource, counteractions associated with at least one of an alert and a target for preventing or mitigating the electronic attack, and business impacts associated with at least one of a target and a counteraction for providing an estimated cost of a business service of a successful attack or an employed counteraction, respectively.

Such a computer security model allows the appropriate modeling of electronic attacks, its effect on a particular data network and means and effects of potential counteractions. It can be used in a variety of software products that are aimed at improving computer security.

According to a further example, the estimated cost provided by a business impact of the model depends at least on one of a duration of a disturbance to the business service, a time of the disturbance of the business service and a degree of the disturbance of the business service. By taking these and similar parameters into account, the security model can provide improved estimates.

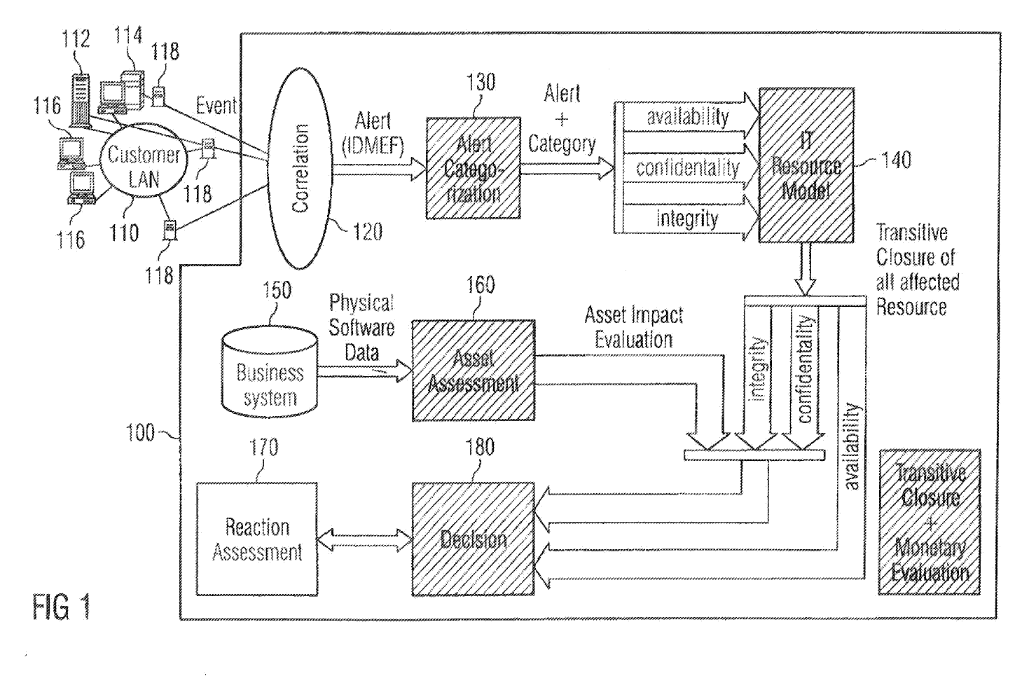

Turning now to the drawings, FIG. 1 shows a computer security system 100. The computer security system 100 monitors a plurality of computer systems connected to a data network 110 such as a company-internal local area network (LAN). The computer systems may either be database servers 112 or server computer systems 114, providing one or several resources or services to other computer systems in the data network 110 or providing web services to customers over the Internet. The computer systems may also be workplace computers 116 which allow accessing the services provided by server computers 114 or other network components such as routers 118, for example. A variety of security systems and software solutions may be installed on the computer systems of the data network, such as firewalls, anti virus software and the like.

The computer systems are connected, either directly or indirectly, with a correlation interface 120 of the computer security system 100. The correlation interface 120 analyzes events occurring in the data network 110 and the computer systems connected thereto. For example, the correlation interface 120 may monitor the amount and type of network messages addressed to or sent from any one of the computer systems of the data network 110. Based on the monitoring, the correlation interface 120 may generate a security alert message. For example, the correlation interface 120 might recognize a disproportionately large number of requests sent to the data network 110 in case of an ongoing denial of service (DoS) attack. The correlation interface 120 may then provide an alert message, for example, according to the Intrusion Detection Message Exchange Format (IDMEF) described in Internet standard RFC 4765, the subject matter of which is incorporated herein by reference.

The alert message is received and processed by an alert module 130. The alert module 130 categorizes the received alert message into one or several of predefined threat types. For example, the alert module can identify whether the received alert message indicates a DoS attack, a virus attack or another type of electronic attack.

Based on the categorization and further information such as the service or resource under attack and the likelihood of a disturbance, an impact analysis module 140 determines the potential impact of the electronic attack. For example, the impact analysis module 140 can simulate what outcome a successful attack on a target computer system will have on the remaining computer systems of the data network 110. For example, the deactivation of a web server may block all external requests to a web shop hosted on the web server. As another example, the successful attack on an internal mail server may severely limit the effectiveness of the internal working of the business. For this purpose, a resource model may be employed. Resource models represent people, equipment, or material used to perform a project or task. Resources have roles, availability, and costs associated with them. Other resource models known from the art may also be employed to provide an impact analysis.

A resource database 150 is provided to estimate the monetary effect of the attack. The resource database 150 provides information about hardware and software resources provided by the individual computer systems. In the example, the resource database 150 also provides data about the interrelationship between the different resources provided by the date network 110 and the potential costs of disturbance of each one of the resources. The cost provided by the resource database 150 may be provided in terms of lookup tables containing absolute values or parameters used to determine the exact costs. For example, the costs may be provided dependent on a time of day, a number of users actually using a particular resource or other factors.

The data provided by the resource database 150 is analyzed by an asset assessment module 160. The asset assessment unit 160 computes the costs for all resources affected by the detected attack based on the data provided. For example, the asset assessment module 160 may compute the potential costs based on a risk analysis of a successful hacking attack to a specific asset.

Preferably, it takes into account the time and duration of a deactivation. For example, it may be acceptable to deactivate a web server providing services to private customers in the middle of the night when only a very low business volume is expected. However, the same deactivation may be very costly during prime business hours when many orders would be lodged over the web server in the same amount of time, resulting in a high cost in terms of lost revenue to the business. Similarly, the cost of deactivating internal resources such as an internal accounting database may be high when a high number of users are connected to the database, for example, during a period of preparing quarterly account statements, whereas the cost may be low at other times when only a few or no users at all are connected to the database.

The computer security system 100 further comprises a defense system 170 to counter any detected electronic attack. The defense system 170 comprises a knowledge database of possible counteractions that can be employed to react to the detected threat. In one example, the defense system comprises a management interface to some or all of the computer systems of the data network 110. In response to a detected attack, such as a virus attack or a DoS attack, the defense system 170 may limit the data flow into or out of the data network 110. For example, the defense system 170 may reconfigure one or more firewalls contained in the data network 110 to block all or a particular type of traffic. Furthermore, it may stop certain services such as web services, mail services or database services to make certain resources unreachable to an attacker. Preferably, the defense system 170 is aware of many possible known computer security counteractions.

The various counteractions provided by the defense system 170 may have a negative impact on the resources monitored by the computer security system 100. This impact will be analyzed by the impact analysis model 140 as described above with respect to the impact of the electronic attack itself. In addition, also the economic impact of implementing a particular counteraction will be analyzed by the asset assessment module 160 based on the data comprised in the resource database 150.

Based on the monetary impact of the detected security alert and any of the considered counteractions, a decision module 180 decides which one of the considered counteractions, if any, is appropriate to respond to the detected electronic attack. In particular, the decision module 180 may exclude any counteractions whose implementation is more costly than the worst possible outcome of the electronic attack itself.

Preferably, the decision module 180 analyzes a number of different counteractions proposed by the defense system 170 and suggests implementing the one counteraction which results in the least cost to the business overall. Further preferably, the decision module 180 also takes into account the probability of the success of the detected electronic attack. For example, if the chance of success of a detected electronic attack is very low and the potential cost of the detected attack are only marginally higher than the estimated cost of implementing a counteraction, the decision module 180 may propose either not to implement any counteraction or to implement a counteraction which is considerably less costly than the product of the likelihood of the electronic attack to succeed and the potential economic impact of the electronic attack.

The decision module 180 may also consider delaying a given counteractions. For example, if, based on the risk assessment, it is not necessary to employ a particular counteraction immediately, it may be economically beneficial to delay its implementation to a time when the business impact is lower. For example, a necessary deactivation, patching and subsequent rebooting of a computer system can be postponed until the end of a business day when fewer users are connected to the service if this results in a lower cost.

The decision module 180 may either just display the result of its evaluation, for example, in the form of a suggestion to a system administrator of the data network 110 which of the possible counteractions are appropriate to counter an electronic attack. Alternatively, in a further automated system, the decision module 180 or the defense system 170 may implement the best counteraction automatically. For example, if a virus infection on one of the computer systems is detected or if a potential back door attack to one of the computer systems is detected, the defense system 170 may configure the firewalls of the data network 110 in such a way that all outgoing or incoming communication to that particular computer system is interrupted. As another example, the defense system 170 may configure a web interface of a server computer 114 in the data network 110 in such a way that it does not accept http-requests from a certain subnet which is launching a DoS attack.

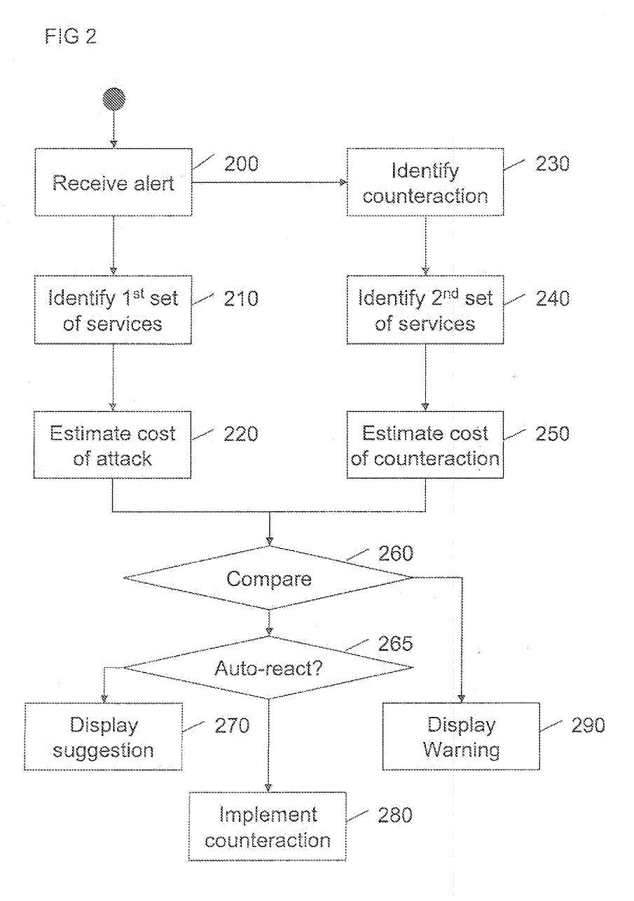

FIG. 2 shows a flow chart of a method for improving computer security. The method may be implemented in a software product or by a combination of software and hardware.

In a first step 200, a security alert is received. The received security alert may be, for example, an IDMEF message in XML-format.

Based on the received security alert, in a step 210, a number of services or targets affected by the attack indicated in the received alert message are identified. For example, a DoS attack on the web server may potentially affect all web servers available publicly over the internet. It may also affect other services that depend, either directly or indirectly, on the operation of the web server.

In a subsequent step 220, the potential cost of the electronic attack is estimated. The costs can be estimated either on a worst case basis, i.e., complete failure of all affected services or resources, or based on a combination of the likelihood of success and the cost associated with the disturbance of the services. In the step 220, both direct costs, such as the costs of increased network traffic or the cost of lost business due to dysfunctional business services, as well as indirect costs, such as contractual penalties or loss of reputation or brand value, can be considered.

In a step 230, which can be performed subsequently or in parallel to the steps described previously, a number of possible counterattacks to prevent or at least mitigate the effect of the electronic attack are identified. For example, the electronic attack can be prevented completely by deactivating all targeted services before they can be infected by a virus or a similar threat. The effects of an electronic attack can be mitigated by deactivating databases providing business critical data such as accounting data, while maintaining other, less relevant databases which provide, for example, product information provided via a web service.

In a further step 240, the services affected by the counteractions identified in step 230 are determined. The step 240 is similar in nature to step 210. As in step 210, in the step 240, the transitive closure of the impact of the selected counteraction on all business services is computed based on interrelationships of the services and resources.

In a further step 250, the cost of the evaluated counteraction is estimated. The step is similar in nature to step 220. In contrast to step 220 however, the counteraction is performed under the control of the computer security method such that the effect of the counteraction is generally known in advance. Nonetheless, the monetary effects will often be estimated, for example, based on the numbers of users connected to a particular resource, or the time of the day in connection with some statistical analysis of the use of a particular service.

In a step 260, the estimated cost of the electronic attack computed in step 220 is compared to the estimated cost of the counteraction considered in step 250. If more than one counteraction has been considered in the steps 230 to 250, the estimated cost for each one of the possible counteractions may be compared individually with the estimated cost of the electronic attack. As a consequence, either the best available counteraction can be selected or the available counteractions can be ranked according to minimum monetary impact on the business.

If the estimated cost of the electronic attack is higher than the cost of the selected counteraction, in a step 265, the system verifies whether it is configured and authorized to automatically react to the detected threat. There might be a further upper threshold level for automatic reaction. For example, the system may not be authorized to implement counteractions beyond a certain associated cost. Inversely, there might be another threshold level with respect to the estimated costs of the attacks such that a counteraction is guaranteed to be implemented, if the predicted cost of the detected threat is very high.

If no automatic response is configured or beyond the authorization of the defense system, a suggestion can be displayed to a person responsible for computer security in step 270. Alternatively, if the system is authorized to respond automatically, the proposed counteraction can be implemented in a step 280.

If the cost of the electronic attack is lower than the estimated cost of any of the appropriate counteractions, however, a warning message can be displayed in a step 290 to a system administrator to inform the administrator about the outcome of the evaluation. The warning message displayed could comprise, among others, the information that implementing any of the considered counteractions is likely to be more costly to the business than the effects of the electronic attack itself.

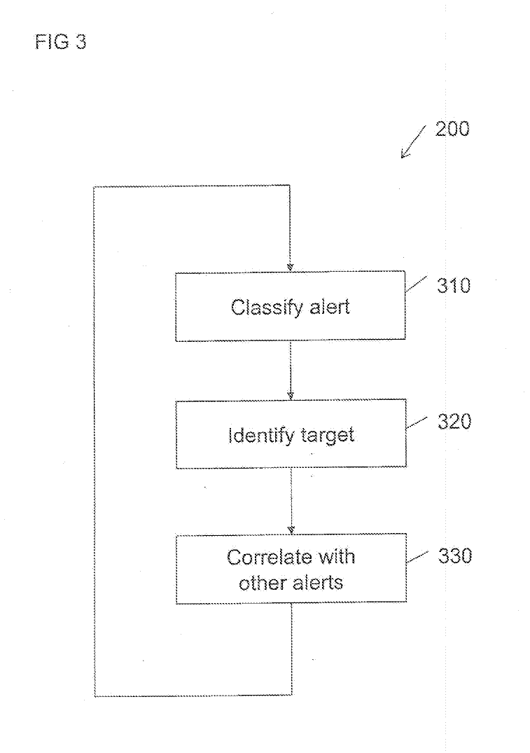

FIG. 3 shows a more detailed view of the method step 200. When a security alert is received, according to FIG. 3 it is first classified in a step 310. For example, in step 310, one or a plurality of received security alerts could be analyzed based on the content of a knowledge database. It can be decided what kind of attack is likely to take place based on the analysis. Examples of possible attacks comprise, among others, virus attacks, denial of service attacks, back door attacks, database query attacks, service discovery attacks, and hacking attacks.

Furthermore, in a step 320, a potential target of an identified electronic attack can be analyzed. For example, based on address information from messages intercepted in the data network 110 or comprised in the alert message, the type or address of the computer system under attack can be analyzed. For example, an attack could be restricted to a particular protocol, such as the hypertext transfer protocol (HTTP), the file transfer protocol (FTP), one or several e-mail protocols such as POP3, SMTP, or IMAP, or one or several computers having a given address or arranged in a common subnet.

In a step 330, the currently processed security alert is correlated with other security alerts. For example, while a single virus received as attachment by an e-mail server may not pose a high risk to the data network 110, several reports of the reception of the same virus by different e-mail servers may increase the overall risk level determined.

As shown in FIG. 3, the individual sub-steps of step 200 are preferably performed continuously to assess the overall security situation of the monitored computer systems.

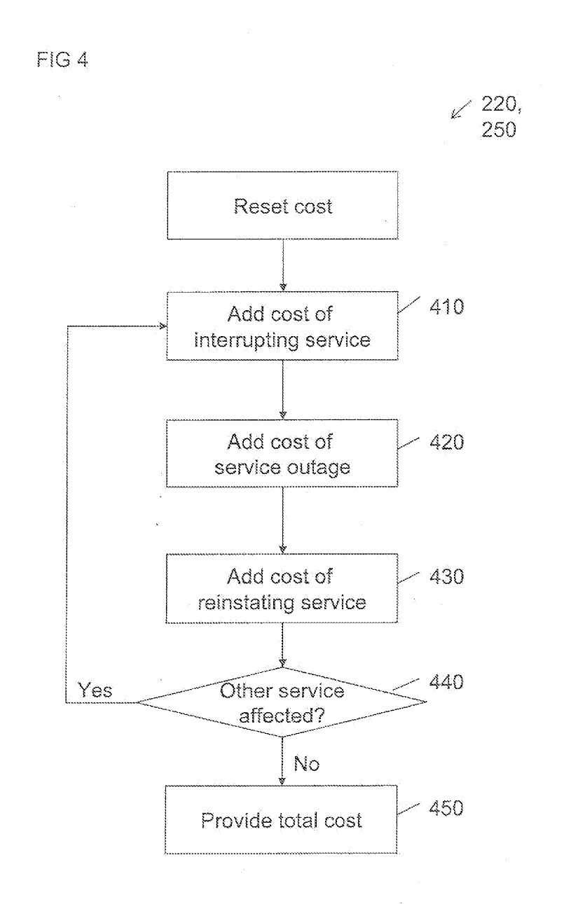

FIG. 4 shows a more detailed view of the steps 220 and 250 used to estimate the costs of the impact of the electronic attack and the considered counteractions, respectively.

Initially, the estimated cost of an impact is set to zero. Then, in a step 410, the costs incurred by interrupting a particular service or resource are added. For example, the cost considered in step 410 may cover the cost for interrupting a number of pending connections with a subsequent lost of corresponding orders. The cost may also relate to the cost for a technician to deactivate a particular computer system or a service running on that computer system.

In a next step 420, the costs of a potential service outage are added. Typically, the costs of a service outage will increase over time. For example, while a service outage of a few seconds or minutes, for example, to reboot a particular server computer may be minimal, the cost of deactivating a web server for a prolonged period of time may be considerable. In step 220, both the time of the actual service outage and the duration are considered.

In a step 430, the costs of reinstating an interrupted service are considered. In particular, the costs of rebuilding a database from a previously generated backup or of adding a new server computer to take over the responsibilities of another server computer which was deactivated are considered.

In a further step 440, the method analyzes whether the deactivation of the resource under scrutiny has effects on other services or resources. For example, deactivation of an e-mail server may also trigger failures on another server, such as a web server, which accesses the e-mail server with an interface. If another server is found to be affected by the interruption of the service under consideration, the loop for estimating costs is repeated for all affected services. In this way, the transitive closure is computed to add all costs of all services affected. If no further services are found to be affected in step 440, in a last step 450, the complete cost estimate is provided.

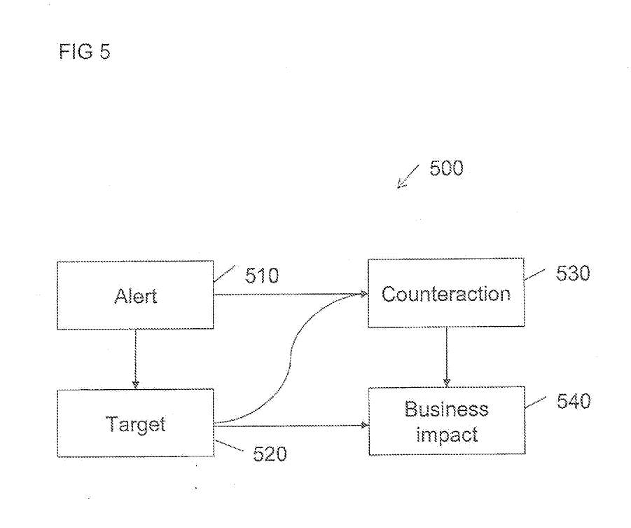

FIG. 5 shows a security model which can be used in a software program to implement the computer security method or computer security system described above. The model 500 comprises four core entities used to model electronic attacks and its potential effects on a managed computer system or data network 110.

Alerts 510 are used to proactively identify and distinguish detected security threats. The security threats are categorized according to the security requirements of the business. Among others, the assessment of an alert depends on the degree of risk or probability of a successful electronic attack, the assessment of potential damage caused by the electronic attack and a distribution capability of the electronic attack. Examples of alerts are, for example, back door attacks, allowing potential intruders access to normally protected services in a data network 110, different types of denial of services such as distributed denial of services or ping of death attacks, which often cause stack overflows in computers accessible via the Internet, or the reception of viruses by e-mail or other data transfer protocols.

The model 500 further comprises targets 520 which represent physical or virtual instances of resources provided by the information technology system monitored. Examples of such targets are database servers 112, server computers 114, client computers 116, routers 118, local software applications such as human resource applications or accounting applications, web applications such as web shops or discussions forums, and infrastructure services such as e-mail servers.

The model 500 further comprises counteractions 530. Counteractions 530 are used to determine some or all of existing countermeasures known to prevent or mitigate a detected electronic attack. The counteractions 530 are used to analyze the dependency of countermeasures based, for example, on the number of actual users working with a target 520, the time of a day, for example, whether it is a working hour or not, the average repair time, the projected time window into which the repair time will fall, the number of affected employees in the case of a service deactivation, and other criteria. Examples of possible countermeasures are the shutdown of a particular service, deactivation of a particular account, deactivation of a particular port, and deactivation of a communication to or from an identified subnet or network address.

The model 500 further comprises business impacts 540 for implementing a business impact analysis. The business impacts provide a monetary evaluation concerning all affected targets 520 based on an identified alert 510. It also provides a monetary evaluation of the possible countermeasures 530. It can further link the estimated business impact to identified target parameters. Simple examples for a business impact of a considered countermeasure are estimated hourly cost associated with the downtime of a web shop during business hours or out of business hours, costs of being unable to receive e-mails per hour, and initial costs of dropping a known number of users due to an emergency shutdown of an application and subsequent costs for a particular duration of the application interruption. Examples of the business impact of the electronic attack itself are similar to the examples described above. In addition, business impacts for electronic attacks may also comprise the costs for a successful attack on database services either directly or indirectly by means of malicious submissions via hacked accounts of a web shop. For example, the impact of a hacked account of a web shop could be estimated based on a transaction limit for the particular account. The costs of a virus attack could be estimated based on the cost of repairing a software installation per affected workplace computer 116, for example.

The system, method and model described allow the implementation of very flexible policies. For example, if a virus attack is discovered, the company inbox can be closed if more than a first number of internal e-mail accounts are affected during work time or if more than a second number of e-mail accounts are attacked out of work time. If more than a third number of e-mails is affected, in addition, the internal traffic can be stopped. In other cases, i.e., if none of the thresholds is reached, an alarm message is triggered but the mail service is continued.

While specific examples of systems, methods and models used for implementing improved computer security have been described, those skilled in the art can easily identify that the described entities, method steps and concepts can easily be extended in various ways. In particular, all described features can be combined with one another to achieve synergetic effects.

1. A computer security method, comprising:
receiving a security alert associated with an electronic attack to at least one computer system of a data network;
identifying a first set of business services which may be affected by the electronic attack;
estimating, based on an identified first set of potentially affected business services, a first potential cost to a business when the electronic attack is successful;
identifying at least one counteraction which may be employed to prevent or mitigate the electronic attack;
identifying a second set of business services which may be affected by the at least one counteraction;
estimating, based on the identified second set of potentially affected business services, a second potential cost to the business when the counteraction is employed; and
comparing the first potential cost and the second potential cost.

2. The method according to claim 1, further comprising:
displaying a suggestion to an operator of the at least one computer system to employ the at least one counteraction if the first potential cost is higher than the second potential cost.

3. The method according to claim 1, further comprising:
displaying a warning to an operator to the at least one computer system not to employ the at least one counteraction if the first potential cost is lower than the second potential cost.

4. The method according to claim 1, further comprising:
employing the at least one counteraction with an automatic administration interface of the at least one computer system if the first potential cost is higher than the second potential cost.

5. The method according to claim 1, wherein
in the step of identifying the at least one counteraction, a plurality of possible counteractions is identified;
the steps of identifying the second set of business services and estimating the second potential cost are performed for each one of the identified possible counteraction; and
based on the step of comparing, the possible counteraction having the least associated second cost is selected.

6. The method according to claim 1, further comprising:
classifying the security alert according to a plurality of predefined threat types; and
providing the at least one possible counteraction based on the classification of the security alert.

7. The method according to claim 6, wherein the plurality of predefined threat types optionally comprises at least one of a virus attack, a denial of service attack, a back door attack, a database query attack, a service discovery attack, and a hacking attack.

8. The method according to claim 1, wherein the first potential cost is estimated based on a likelihood of success of the electronic attack.

9. The method according to claim 8, wherein
a plurality of security alerts associated with the electronic attack is received from a plurality of computer systems; and
the likelihood of the success of the electronic attack is determined based the plurality of received security alerts.

10. The method according to claim 1, wherein the first and second potential costs are estimated based on at least one of the type of the business services affected, a number of users affected and a time of day, week, or year.

11. A computer security system, comprising:
a resource model that associates business services provided by at least one data network with resources of the at least one data network;
a business impact model that provides estimates of monetary cost caused by disturbances of each one of the business services;
a security alert module that maps a received security alert associated with an electronic attack to at least one resource of the at least one data network targeted by the electronic attack; and
a defense system that provides possible counteractions to a received security alert, wherein the defense system selects at least one counteraction based on the estimated cost of employing the at least one counteraction provided by the business impact model.

12. The system according to claim 11, wherein the defense system selectively deactivates resources and/or business services of the at least one data network to counteract the electronic attack and the business impact model estimates a cost of the counteraction based on estimated costs of disabling the business services dependent on the deactivated resources and/or business services, respectively.

13. The system according to claim 11, wherein the security alert module comprises a knowledge database that associates a received security alert with resources of the at least one data network based on at least one of automated learning from, statistical analysis of, and heuristics based on previous electronic attacks.

14. A computer security model for use in a software product for assessing a business impact of an electronic attack, the model comprising:
alerts associated with an electronic attack for assessing a received security alert;
targets associated with resources of at least one data network for mapping a received security alert to at least one resource;
counteractions associated with at least one of an alert and a target for preventing or mitigating the electronic attack; and
business impacts associated with at least one of a target and a counteraction for providing an estimated cost on a business service of a successful attack or employed counteraction, respectively.

15. The model according to claim 14, wherein the estimated cost provided by a business impact depends at least on one of a duration of a disturbance to the business service, a time of a disturbance of the business service, a cost of repair of the business service, and a degree of disturbance of the business service.
